(19) United States
(12) Patent Application Publication
(10) Pub. No.: US 2023/0064522 A1
(43) Pub. Date: Mar. 2, 2023

(54) FIXER FLUIDS

(71) Applicant: HEWLETT-PACKARD DEVELOPMENT COMPANY, L.P., Spring, TX (US)

(72) Inventors: Dennis Z. Guo, San Diego, CA (US); Jie Zheng, San Diego, CA (US)

(21) Appl. No.: 17/916,450

(22) PCT Filed: Jun. 15, 2020
(86) PCT No.: PCT/US2020/037731

§ 371 Date: Sep. 30, 2022

(51) Int. Cl. C09D 11/54; C09D 11/322; C09D 11/38; C09D 11/40; D06P 5/00; D06P 5/22; D06P 5/30

(52) U.S. Cl. CPC C09D 11/54; C09D 11/322; C09D 11/38; C09D 11/40; D06P 5/002; D06P 5/22; D06P 5/30

(57) ABSTRACT

The present disclosure describes fixer fluids, fluid sets for textile printing, and methods of textile printing. In one example, a fixer fluid can include a fixer vehicle and from 0.5 wt % to 12 wt % of an azetidinium-containing polyamine polymer dispersed in the fixer vehicle. The fixer vehicle can include water, a surfactant, and an acid having from 0 to 6 carbon atoms.

### BACKGROUND

Inkjet printing has become a popular way of recording images on various media. Some of the reasons include low printer noise, variable content recording, capability of high speed recording, and multi-color recording. This can be obtained at a relatively low cost to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF THE DRAWINGS

FIG. 1 schematically represents an example fixer fluid, as well as an example fluid set including an ink composition and the fixer fluid in accordance with the present disclosure;

FIG. 2 schematically depicts an example textile printing system and method that includes an ink composition, a fixer fluid, a print media substrate, fluid jet pens, and a heating device in accordance with the present disclosure; and

FIG. 3 depicts an example method of printing on textiles in accordance with the present disclosure.

### DETAILED DESCRIPTION

The present disclosure describes fixer fluids, fluid sets, and methods of textile printing. In one example, a fixer fluid includes a fixer vehicle and from 0.5 wt % to 12 wt % of an azetidinium-containing polyamine polymer dispersed in the fixer vehicle. The fixer vehicle includes water, a surfactant, and an acid having from 0 to 6 carbon atoms. In some examples, the acid may not include a carboxyl group, an amino group, a thiol group, or a hydroxyl group where the hydroxyl group is attached to a carbon atom. In further examples, the acid can be a sulfonic acid, a nitric acid, or a phosphoric acid. In still further examples, the acid can be included in an amount of from 0.1 wt % to 5 wt % with respect to the total weight of the fixer fluid. In some examples, the fixer fluid may not include an anti-kogation additive other than the acid. In certain examples, the azetidinium-containing polyamine polymer can include from 2 to 12 carbon atoms between individual amine groups. In further examples, the azetidinium-containing polyamine polymer can have a molar ratio of crosslinked or uncrosslinked azetidinium groups to amine groups from 0.1:1 to 10:1.

The present disclosure also describes fluid sets for textile printing. In one example, a fluid set for textile printing includes an ink composition and a fixer fluid. The ink composition includes an aqueous ink vehicle, a pigment, and a polymeric binder. The fixer fluid includes a fixer vehicle including water, a surfactant, and an acid having from 0 to 6 carbon atoms, and from 0.5 wt % to 12 wt % of an azetidinium-containing polyamine polymer dispersed in the fixer vehicle. In some examples, the acid may not include a carboxyl group, an amino group, a thiol group, or a hydroxyl group where the hydroxyl group is attached to a carbon atom. In other examples, the acid can be a sulfonic acid, a nitric acid, or a phosphoric acid. In further examples, the azetidinium-containing polyamine polymer can include from 2 to 12 carbon atoms between individual amine groups, and can have a molar ratio of crosslinked or uncrosslinked azetidinium groups to amine groups from 0.1:1 to 10:1. In still further examples, the polymeric binder in the ink composition can include a polyester polyurethane, an acrylic latex, or a combination thereof.

The present disclosure also describes methods of textile printing. In one example, a method of textile printing includes jetting a fixer fluid onto a fabric substrate. The fixer fluid includes a fixer vehicle including water, a surfactant, and an acid having from 0 to 6 carbon atoms. The fixer fluid further includes from 0.5 wt % to 12 wt % of an azetidinium-containing polyamine polymer dispersed in the fixer vehicle. The method also includes jetting an ink composition onto the fabric substrate in contact with the fixer fluid. The ink composition includes an aqueous ink vehicle, a pigment, and a polymeric binder. In some examples, the method can also include heating the fabric substrate having the fixer fluid and the aqueous ink composition applied thereto to a temperature from 80° C. to 200° C. for a period from 5 seconds to 10 minutes. In further examples, the acid may not include a carboxyl group, an amino group, a thiol group, or a hydroxyl group where the hydroxyl group is attached to a carbon atom; the azetidinium-containing polyamine polymer can include from 2 to 12 carbon atoms between individual amine groups; and the azetidinium-containing polyamine polymer can have a molar ratio of crosslinked or uncrosslinked azetidinium groups to amine groups from 0.1:1 to 10:1.

In addition to the examples described above, the fixer fluids, the fluid sets, and the methods of printing will be described in greater detail below. It is also noted that when discussing the fixer fluid, the fluid sets, or methods of printing described herein, these relative discussions can be considered applicable to the other examples, whether or not they are explicitly discussed in the context of that example. Thus, for example, in discussing an azetidinium-containing polyamine polymer relative to the fixer fluid, such description is also relevant to the fluid set and the methods of printing described herein, and vice versa.

Fixer Fluids

The present disclosure describes fixer fluids and fluid sets that can include the fixer fluids. These fluid sets can be used for printing on fabric substrates, for example. In some examples, the fixer fluid can help printed ink adhere to the substrate, which can increase the durability of printed images on the substrate. In some textile applications, such as clothing, the substrate may be washed multiple times. The fixer fluids described herein can help provide printed images that have good washfastness, or the ability to withstand multiple washings without degradation of the image.

In certain examples, the fixer fluid can include an azetidinium-containing polyamine polymer dispersed in a fixer vehicle. The azetidinium-containing polyamine polymer can include functional groups that can react with functional groups in the ink and/or the substrate that are used with the fixer fluid. In certain examples, the azetidinium-containing polyamine polymer can act as a crosslinker for a polymeric binder in the ink. In further examples, the azetidinium-containing polyamine polymer can crosslink with both the polymeric binder in the ink and the substrate. In this way, the azetidinium-containing polyamine polymer can help form a strong bond between the substrate and the ink.

However, in some cases, the azetidinium-containing polyamine polymer can make the fixer fluid less compatible with certain digital printing processes, such as thermal inkjet printing. In thermal inkjet printing, kogation can occur when a fluid is jetted from a printhead repeatedly over a period of time. Kogation can refer to the buildup of residue on the thermal resistor of the printhead, which can interfere with the jetting ability of the printhead. In some cases, the azetidinium-containing polyamine polymer can exacerbate the kogation process and cause inkjet printheads to fail quickly.

The fixer fluids described herein can also include an acid with 0 to 6 carbon atoms. This acid can be an inorganic acid or a small organic acid molecule with 6 carbon atoms or fewer. This type of acid compound has been found to be effective for reducing kogation when the acid is included in the fixer fluid together with the azetidinium-containing polyamine polymer. The fixer fluid can be successfully printed using thermal inkjet printheads. When used together with the ink compositions described herein, the fixer fluid can provide printed images on fabric substrate with good washfastness.

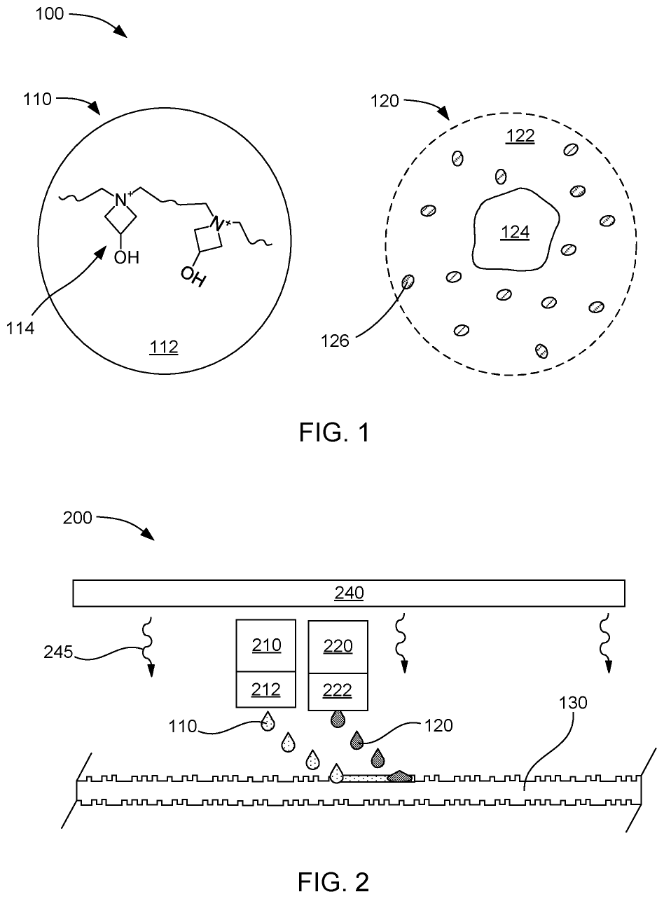

FIG. 1 shows a schematic representation of a fluid set 100 that includes a fixer fluid 110. The fixer fluid can include an azetidinium-containing polyamine 114 dispersed in a fixer vehicle 112. The fixer vehicle can include water, a surfactant, and an acid having from 0 to 6 carbon atoms. In some examples, the azetidinium-containing polyamines can be less stable in basic environments. Accordingly, in one example, the pH of the fixer fluid can be from 0 to less than 7, from 0 to 6, from 1 to 5, from 0 to 4, or from 1 to 6, or from 0 to 5, or from 0.5 to 2, for example. pH can be measured using a pH meter from Fisher Scientific, USA (ACCUMET™ XL250).

As mentioned, the fixer vehicle 112 can include water, and typically, the fixer fluid is an aqueous fixer fluid with a predominant concentration of water. For example, the water content can be present in the fixer fluid at from 60 wt % to 97.5 wt %, from 70 wt % to 95 wt %, from 80 wt % to 95 wt %, or from 85 wt % to 97.5 wt %. In some specific examples, in addition to the surfactant and the acid having from 0 to 6 carbon atoms, the fixer vehicle can include additional components such as biocides, organic co-solvents, and others. However, in certain examples, the fixer fluid can be devoid of organic co-solvents. In further examples, the fixer fluid can be devoid of anti-kogation additives other than the acid having from 0 to 6 carbon atoms. In certain examples, the fixer fluid can consist of water, an acid having from 0 to 6 carbon atoms, a surfactant, and the azetidinium-containing polyamine polymer dispersed in the fixer vehicle.

If organic co-solvents are used, examples may include polar solvents, such as alcohols, amides, esters, ketones, and/or ethers, etc. In additional detail, solvents that can be used can include aliphatic alcohols, aromatic alcohols, diols, glycol ethers, polyglycol ethers, formamides, acetamides, and/or long chain alcohols, etc. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, substituted or unsubstituted formamides, and/or substituted or unsubstituted acetamides, etc. More specific examples of organic solvents can include glycerol, dimethyl sulfoxide, sulfolane, glycol ethers, alkyldiols such as 1,2-hexanediol, and/or ethoxylated glycerols such as LEG-1, etc.

The surfactant that is included in the fixer fluid can include a single surfactant or a combination of multiple surfactants, in various examples. Some surfactants can be water-soluble. Example surfactants can include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, or a combination thereof. In further examples, the surfactant can include a nonionic surfactant, such as a SURFYNOL® surfactant, e.g., SURFYNOL® 440 or SURFYNOL® 465 (from Evonik, Germany), or a TERGITOL™ surfactant, e.g., TERGITOL™ TMN-6 (from Dow Chemical, USA). The surfactant or combinations of surfactants can be included in the ink composition at from 0.01 wt % to 5 wt % and, in some examples, can be present at from 0.05 wt % to 3 wt %, or from 0.1 wt % to 1.5 wt %, of the ink compositions.

In certain examples, the fixer fluid can be devoid of certain surfactants that include phosphate esters. Examples of phosphate ester surfactants can include CRODAFOS™ N3A and/or CRODAFOS™ N10A, both from Croda International PLC, United Kingdom. In other examples, the fixer fluid can be devoid of anionic surfactants.

As mentioned above, the fixer vehicle can also include an acid having from 0 to 6 carbon atoms. In some examples, the acid can be an inorganic acid. In other examples, the acid can be an organic acid. Certain types of functional groups may be reactive with the azetidinium-containing polyamine polymer that is included in the fixer fluid. In some examples, the acid can be devoid of such reactive functional groups. In certain examples, the acid can be devoid of carboxyl groups, amino groups, and thiol groups. In other examples, the acid can be devoid of some of these functional groups, or one of these functional groups. In further examples, the acid can be devoid of hydroxyl groups that are attached to a carbon atom in the acid molecule. For example, the acid molecule can include —OH groups that are attached to a sulfur atom or a phosphorus atom, but no —OH groups attached to a carbon atom. In certain examples, the acid can be a sulfonic acid, a nitric acid, or a phosphoric acid. In a particular example, the acid can be nitric acid or methanesulfonic acid.

The amount of the acid having from 0 to 6 carbon atoms in the fixer fluid can be sufficient to reduce kogation during printing, and sufficient to reduce the pH of the fixer fluid to an appropriate level, as described above. In some examples, the acid can be included in an amount of from 0.1 wt % to 5 wt %. In other examples, the acid can be included in an amount from 0.5 wt % to 3 wt %, or from 0.5 wt % to 2 wt %, or from 0.8 wt % to 1.5 wt %.

With specific reference to the azetidinium-containing polyamine 114 that is present in the fixer fluid 110, FIG. 1 presents a representative simplified schematic formula for illustrative purposes, and should not be considered limiting. The azetidinium-containing polyamine selected for use can include any of a number of cationic polyamines with a plurality of azetidinium groups. In an uncrosslinked state, as shown in Formula I below, an azetidinium group has a structure as follows:

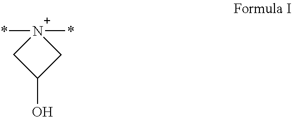 [SMILES: *[N+]1(*)CC(O)C1]

As shown in Formula I, this structure is not intended to show repeating units, but rather merely a polymer that includes the azetidinium groups shown in Formula I, including azetidinium-containing polyamines having a weight average molecular weight from 1,000 Mw to 2,000,000 Mw, from 2,000 Mw to 1,000,000 Mw, from 5,000 Mw to 200,000 Mw, from 5,000 Mw to 100,000 Mw, or from 20,000 to 1,000,000 Mw, for example. The asterisks (*) in Formula I represent portions of the various organic groups, polymeric portions, functional moieties, etc., for example.

In some examples, the azetidinium-containing polyamine can be derived from the reaction of a polyalkylene polyamine (e.g. ethylenediamine, bishexamethylenetriamine, and hexamethylenediamine, for example) with an epihalohydrin (e.g. epichlorohydrin, for example) (referred to as PAmE resins). In some specific examples, the azetidinium-containing polyamine can include the structure of Formula II, as follows:

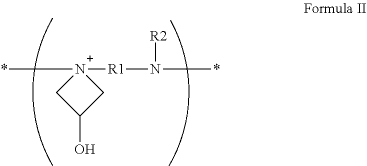

where R1 can be a substituted or unsubstituted C₂-C₁₂ alkyl group (such as a linear alkyl group) and R2 can be H or CH₃. When R2 is H, the backbone nitrogen is a secondary amine. When R2 is CH₃, the backbone nitrogen is a tertiary amine. In some additional examples, R1 can be a C₂-C₁₀, C₂-C₈, or C₂-C₆ linear alkyl group. For example, there can be from 2 to 12 carbon atoms between amine groups (including azetidinium quaternary amine and other amines along the backbone). In other examples, there can be from 3 to 12, from 2 to 10, from 3 to 10, from 2 to 8, from 3 to 8, from 2 to 6, or from 3 to 6 carbon atoms between amine groups in the azetidinium-containing polyamine. In some examples, where R1 is a C₃-C₁₂ (or C₃-C₁₀, C₃-C₈, C₃-C₆, etc.) linear alkyl group, a carbon atom along the alkyl chain can be a carbonyl carbon, with the proviso that the carbonyl carbon does not form part of an amide group (i.e. R1 does not include or form part of an amide group). In some additional examples, a carbon atom of R1 can include a pendent hydroxyl group. The number of units as shown in Formula II can be any number of units that results in an azetidinium-containing polyamine having a weight average molecular weight from 1,000 Mw to 2,000,000 Mw, from 2,000 Mw to 1,000,000 Mw, from 5,000 Mw to 200,000 Mw, from 5,000 Mw to 100,000 Mw, or from 20,000 to 1,000,000 Mw, for example. These units can be repeating along the polymer, along portions of the polymer, and/or can have other moieties between individual units shown in Formula II. Thus, the asterisks (*) in Formula II represent portions of polymer that are not shown, but could include various organic groups, polymeric portions, functional moieties, etc., for example.

As can be seen in Formula II, the azetidinium-containing polyamine can include a quaternary amine (e.g. azetidinium group) and a non-quaternary amine (e.g., mostly tertiary amine). In some specific examples, the azetidinium-containing polyamine can include a quaternary amine and a tertiary amine. In some additional examples, the azetidinium-containing polyamine can include a quaternary amine and a secondary or tertiary amine. It is noted that, in some examples, some of the azetidinium groups of the azetidinium-containing polyamine can be crosslinked to a second functional group along the azetidinium-containing polyamine. Whether or not this is the case, the azetidinium-containing polyamine can have a ratio of crosslinked or uncrosslinked azetidinium groups to other amine groups of from 0.1:1 to 10:1, from 0.1:1 to 5:1, or from 1:1 to 10:1. In other examples, the azetidinium-containing polyamine can have a ratio of crosslinked or uncrosslinked azetidinium groups to other amine groups of from 0.5:1 to 2:1. Non-limiting examples of commercially available azetidinium-containing polyamines that fall within these ranges of azetidinium groups to amine groups include CREPETROL™ 73, KYMENE™ 736, POLYCUP™ 1884, POLYCUP™ 7360, and POLYCUP™ 7360A, which are available from Solenis LLC (Delaware, USA). Other compounds from this or other companies can likewise be used.

With more specific detail regarding the POLYCUP™ family of azetidinium-containing polyamines, these resins tend to be formaldehyde-free, water-based crosslinking resins that are reactive with amine groups, carboxyl groups, hydroxyl groups, and thiol groups. Many of these types of groups can be present at the surface of fabric substrates, so in addition to crosslinking that may occur with the polyurethanes that are present in the ink compositions, there can be additional crosslinking at the surface of the print media substrate, particularly with respect to many different types of synthetic and/or natural fabrics. The azetidinium-containing polyamines, such as these POLYCUP™ brand resins, can promote water resistance to the printed images on the fabric. As one specific example, POLYCUP™ 7360 is a thermosetting polyamine epichlorohydrin that can include the polymer in a fluid carrier at about 38 wt % solids, and can have a range of viscosities from about 180 cP to about 300 cP at 25° C., for example. The pH of the dispersion as provided can be from about pH 2.5 to about pH 4. Curing can be modulated by modification of concentration, time, temperature, pH, etc. For example, by bringing the pH of a polyamine epichlorohydrin up to about pH 7 or to about pH 9 (by fixer fluid formulation, by mixing with ink on the fabric substrate, by the pH of the fabric substrate, etc.), curing at temperatures from about 80° C. to about 150° C. can be effective. With this and other examples, curing can be carried out using convection heating, air-draft ovens, radiant heat, infrared heating, etc. Furthermore, with these types of materials, natural crosslinking can continue to occur, if crosslinking groups are still available, at ambient temperatures over a period of weeks, e.g., one day to 6 weeks, with some polymers.

Thus, when the fixer fluid is printed on the print media substrate, such as a fabric substrate (not shown in FIG. 1, but shown in FIG. 2), suitable reactive groups that may be present at a surface of the polyurethane binder in the ink composition, and in some instances, hydroxyl groups (e.g. for cotton), amine groups (e.g. for nylon), thiol groups (e.g. for wool), or other suitable reactive groups that may be present at the surface of the print media substrate, can interact with the azetidinium groups in the fixer fluid to generate a high quality image that exhibits durable washfastness as demonstrated in the examples hereinafter. The cationic polymer including an azetidinium-containing polyamine can be present in the fixer fluid at from 0.5 wt % to 12 wt %, from 1 wt % to 7 wt %, from 2 wt % to 6 wt %, from 3 wt % to 5 wt %, or from 3 wt % to 6 wt %, for example.

Non-limiting but illustrative example reactions between the azetidinium group and various reactive groups are illustrated below in Formula as follows:

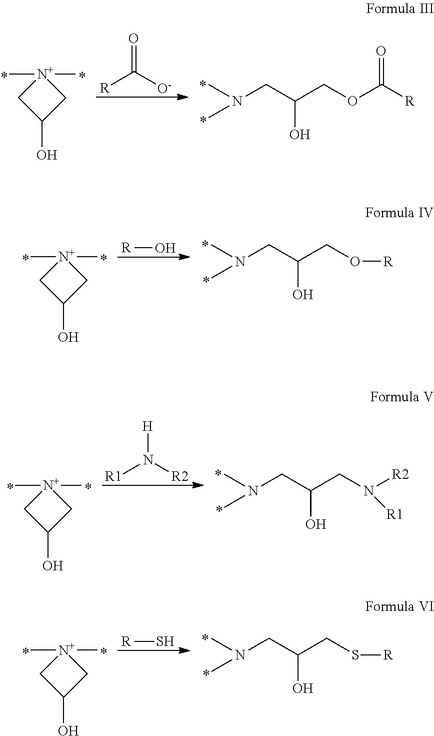

As with Formulas I and II, in Formulas III-VI, the asterisks (*) represent portions of the various organic compounds or polymer that may not be directly part of the reaction shown in Formulas I-VI, and are thus not shown, but could be any of a number of organic groups, polymeric portions, functional moieties, etc., for example. Likewise, R1 and R2 can be H or any of a number of organic groups, such as those described previously in connection with R1 or R2 in Formula II, without limitation.

In further detail, in accordance with examples of the present disclosure, the azetidinium groups present in the fixer fluid can interact with the binder of the ink, such as polyurethane or acrylic binders, or the print media substrate, or both to form a covalent linkage therewith, as shown in Formulas III-VI above. Other types of reactions can also occur, but Formulas III-VI are provided by way of example to illustrate examples of reactions that can occur when the ink composition, the print media substrate, or both come into contact with the fixer fluid, e.g., interaction or reaction with the substrate, interaction or reaction between different types of polyurethane polymer, interaction or reaction between different types of azetidinium-containing polyamines, interactions or reactions with different molar ratios (other than 1:1, for example) than that shown in Formulas etc.

Fluid Sets for Textile Printing

Returning to FIG. 1, a fluid set 100 is shown that includes the fixer fluid 110 described above, which includes an azetidinium-containing polyamine 114 dispersed in a fixer vehicle 112. The fixer vehicle can include water, a surfactant, and an acid having from 0 to 6 carbon atoms.

The fluid set 100 also includes an ink composition 120. The ink composition in this example includes an ink vehicle 122, a pigment 124, and a polymeric binder 126. The ink vehicle can include water with a water content (based on the weight of the ink composition) from 50 wt % to 90 wt %, from 60 wt % to 90 wt %, or from 70 wt % to 85 wt %, for example. The ink vehicle can also include organic co-solvent, with one or multiple organic co-solvents being present in aggregate based on the weight of the ink composition at from 4 wt % to 30 wt %, from 6 wt % to 20 wt %, or from 8 wt % to 15 wt %, for example. Other ink vehicle components can also be included, such as surfactant, antibacterial agent, etc. However, as part of the ink composition, the pigment (dispersed by dispersant surface-associated dispersant) and the polymeric binder polymer can be included or carried by the ink vehicle.

In further detail regarding the ink vehicle 122, co-solvent(s) can be present and can include any co-solvent or combination of co-solvents that are compatible with the pigment and polymeric binder. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The ink vehicle 122 can also include surfactant. The surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, or a combination thereof. In some examples, the surfactant can include a nonionic surfactant, such as a SURFYNOL® surfactant, e.g., SURFYNOL® 440 (from Evonik, Germany), or a TERGITOL™ surfactant, e.g., TERGITOL™ TMN-6 (from Dow Chemical, USA). In another example, the surfactant can include an anionic surfactant, such as a phosphate ester of a C₁₀ to C₂₀ alcohol, a polyethylene glycol oleyl mono phosphate, a polyethylene glycol oleyl diphosphate, an oleth-based phosphate, or a mixture thereof. Examples of phosphate ester surfactants that can be used include CRODAFOS™ N3A and/or CRODAFOS™ N10A, both from Croda International PLC, United Kingdom. The surfactant or combinations of surfactants, if present, can be included in the ink composition at from 0.01 wt % to 5 wt % and, in some examples, can be present at from 0.05 wt % to 3 wt %, or from 0.1 wt % to 1.5 wt %, of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, ACTICIDE®, e.g., ACTICIDE® B20 (Thor Specialties Inc.), NUOSEPT™ (Nudex, Inc.), UCARCIDE™ (Union carbide Corp.), VANCIDE® (R.T. Vanderbilt Co.), PROXEL™ (ICI America), or a combination thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives to modify properties of the ink as desired.

The pigment 124 that is dispersed in the ink vehicle 122 can be any of a number of pigment colorants of any of a number of primary or secondary colors, or can be black, gray, or white, for example. More specifically, if a color pigment is used, the pigment colorant may include black, white, cyan, magenta, yellow, red, blue, violet, orange, green, etc. In one example, the ink composition 120 can be a black ink with a carbon black pigment. In another example, the ink composition can be a white ink with a titanium dioxide pigment. In another example, the ink composition can be a cyan or green ink with a copper phthalocyanine pigment, e.g., Pigment Blue 15:0, Pigment Blue 15:1, Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, P048, P049, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., Pigment Yellow 74 and Pigment Yellow 155. In one example, the pigment can include aromatic moieties.

With respect to dispersing the pigment 124 in the ink composition, the pigment can be dispersed by a dispersing agent or dispersing polymer. In some examples, the pigment can be dispersed by a polymer dispersant, such as a styrene (meth)acrylate dispersant, or another dispersant suitable for keeping the pigment suspended in the ink vehicle 122. For example, the dispersant can be any dispersing (meth)acrylate polymer, or other type of polymer, such as a styrene maleic acid copolymer. In one specific example, the (meth)acrylate polymer can be a styrene-acrylic type dispersant polymer, as it can promote Π-stacking between the aromatic ring of the dispersant and various types of pigments, such as copper phthalocyanine pigments, for example. Examples of commercially available styrene-acrylic dispersants can include JONCRYL®671, JONCRYL®71, JONCRYL 96, JONCRYL®680, JONCRYL®683, JONCRYL®678, JONCRYL®690, JONCRYL®296, JONCRYL®671, JONCRYL®696 or JONCRYL ECO 675 (all available from BASF Corp., Germany).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). This can be the case for either dispersant polymer for pigment dispersion or for dispersed polymer binder that may include co-polymerized acrylate and/or methacrylate monomers. Also, in some examples, the terms “(meth)acrylate” and “(meth)acrylic acid” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other organic chemistry concepts. In still further detail, this definition as to terms (meth)acrylic, (meth)acrylate, or the like can be applicable to other types of polymer that may be present in the ink compositions described herein, such as in the case of (meth)acrylic latex particles used, in some examples, as the polymeric binder in the ink composition.

Turning now to the polymeric binder 126, example polymeric binders that can be used can be in the form of (meth)acrylic latex particles, polyurethane particles, or a combination thereof, for example. In FIG. 1, the relative sizes of the pigment and the polymeric binder are not drawn to scale. Regardless of the type of polymeric binder present, the polymeric binder particles can be present in the ink composition in an amount from 2 wt % to 15 wt %, from 4 wt % to 12 wt %, from 6 wt % to 11 wt %, from 8 wt % to 12 wt %, or from 5 wt % to 9 wt %, for example. The polymeric binder particles can have a D50 particle size or a volume averaged particle size from 25 nm to 900 nm, from 50 nm to 750 nm, from 100 nm to 500 nm, or from 150 nm to 400 nm, for example.

The polymeric binder or binder particles can have a weight average molecular weight, for example, from 2,000 Mw to 500,000 Mw, from 4,000 Mw to 250,000 Mw, from 5,000 Mw to 200,000 Mw, for example. The polymeric binder particles can have an acid number from 0 to 180, from 1 to 100, from 1 to 20, or from 2 to 15, for example.

Regarding the (meth)acrylic latex particles that may be used as the polymeric binder, any variety of (meth)acrylic latexes can be used. For example, any of a number of dispersed polymer prepared from acrylate and/or methacrylate monomers, including an aromatic (meth)acrylate monomer that results in aromatic (meth)acrylate moieties as part of the acrylic latex can be used. In some examples, the (meth)acrylic latex particles can include a single heteropolymer that is homogenously copolymerized. In another example, a multi-phase (meth)acrylic latex polymer can be prepared to form the (meth)acrylic latex particles, and the polymer can include a first heteropolymer and a second heteropolymer. The two heteropolymers can be physically separated in the (meth)acrylic latex particles, such as in a core-shell configuration, a two-hemisphere configuration, smaller spheres of one phase distributed in a larger sphere of the other phase, interlocking strands of the two phases, and so on. If a two-phase polymer, the first heteropolymer phase can be polymerized from two or more aliphatic (meth)acrylate ester monomers or two or more aliphatic (meth)acrylamide monomers. The second heteropolymer phase can be polymerized from a cycloaliphatic monomer, such as a cycloaliphatic (meth)acrylate monomer or a cycloaliphatic (meth)acrylamide monomer. The first or second heteropolymer phase can include the aromatic (meth)acrylate monomer, e.g., phenyl, benzyl, naphthyl, etc. In one example, the aromatic (meth)acrylate monomer can be a phenoxylalkyl (meth)acrylate that forms a phenoxylalkyl (meth)acrylate moiety within the (meth)acrylic latex particles, e.g. phenoxylether, phenoxylpropyl, etc. The second heteropolymer phase can have a higher T_{g} than the first heteropolymer phase in one example. The first heteropolymer composition may be considered a soft polymer composition and the second heteropolymer composition may be considered a hard polymer composition. If a two-phase heteropolymer, the first heteropolymer composition can be present in the (meth)acrylic latex particle in an amount ranging from 15 wt % to 70 wt % of a total weight of the (meth)acrylic latex particle, and the second heteropolymer composition can be present in an amount ranging from 30 wt % to 85 wt % of the total weight of the polymer particle.

In other terms, whether there is a single heteropolymer phase, or there are multiple heteropolymer phases, heteropolymer(s) or copolymer(s) can include a number of various types of copolymerized monomers, including aliphatic(meth)acrylate ester monomers, such as linear or branched aliphatic (meth)acrylate monomers, cycloaliphatic (meth)acrylate ester monomers, or aromatic monomers. However, in accordance with the present disclosure, the aromatic monomer(s) selected for use can include an aromatic (meth)acrylate monomer.

Examples of aromatic (meth)acrylate monomers that can be used in a heteropolymer or copolymer of the (meth)acrylic latex (single-phase, dual-phase in one phase or both phases, etc.) include 2-phenoxylethyl methacrylate, 2-phenoxylethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, naphthyl methacrylate, naphthyl acrylate, phenyl methacrylate, phenyl acrylate, or a combination thereof. In one example, the (meth)acrylic latex particles can include a phenoxylethyl acrylate and a phenoxylethyl methacrylate, or a combination of a phenoxylethyl acrylate and phenoxylethyl methacrylate.

Examples of the linear aliphatic (meth)acrylate monomers that can be used include ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, or a combination thereof.

Examples of the cycloaliphatic (meth)acrylate ester monomers can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, or a combination thereof.

In other examples, the (meth)acrylic latex particles can include polymerized copolymers, such as emulsion polymers of one or multiple monomers, and can also be prepared using a reactive surfactant in some examples. Example reactive surfactants can include polyoxyethylene alkylphenyl ether ammonium sulfate surfactant, alkylphenol ethoxylate free polymerizable anionic surfactant, sodium polyoxyethylene alkylether sulfuric ester based polymerizable surfactant, or a combination thereof. Commercially available examples include HITENOL® AR series, HITENOL® KH series (e.g. KH-05 or KH-10), or HITENOL® BC series, e.g., HITENOL® BC-10, BC-30, (all available from Montello, Inc., Oklahoma), or combinations thereof. Example monomers that can be used include styrene, alkyl methacrylate (for example C₁ to C₈ alkyl methacrylate), alkyl methacrylamide (for example C₁ to C₈ alkyl methacrylamide), butyl acrylate, methacrylic acid, or combinations thereof. In some examples, the (meth)acrylic latex particles can be prepared by combining the monomers as an aqueous emulsion with an initiator. The initiator may be selected from a persulfate, such as a metal persulfate or an ammonium persulfate. In some examples, the initiator may be selected from a sodium persulfate, ammonium persulfate or potassium persulfate.

If the polymeric binder selected for use in the ink composition is a polyurethane binder, any of a number of polyurethane binders can be selected. In an example, the polyurethane binder can be a polyester polyurethane. In an example, the polyester-polyurethane binder can be a sulfonated polyester-polyurethane binder. The sulfonated polyester-polyurethane binder can include diaminesulfonate groups. In an example, the polyurethane-based binder can be the polyester-polyurethane binder, the polyester-polyurethane binder can be a sulfonated polyester-polyurethane binder, and can be one of: i) an aliphatic compound including multiple saturated C4 to C10 carbon chains and/or an alicyclic carbon moiety, that is devoid of an aromatic moiety, or ii) an aromatic compound including an aromatic moiety and multiple saturated carbon chain portions ranging from C4 to C10 in length.

In one example, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C2 to C10, C3 to C9, or C3 to C6 alkyl. The sulfonated polyester-polyurethane binder can also contain alicyclic carbon moiety. These polyester-polyurethane binders can be described as “aliphatic” because these carbon chains are saturated and because they are devoid of aromatic moieties. An example of a commercially available anionic aliphatic polyester-polyurethane binder that can be used is IMPRANIL® DLN-SD (CAS #375390-41-3; Mw 133,000; Acid Number 5.2; Tg −47° C.; Melting Point 175-200° C.) from Covestro (Germany). Example components used to prepare the IMPRANIL® DLN-SD or other anionic aliphatic polyester-polyurethane binders suitable for the examples disclosed herein can include pentyl glycols (e.g., neopentyl glycol); C4 to C10 alkyldiol (e.g., hexane-1,6-diol); C₄ to C₁₀ alkyl dicarboxylic acids (e.g., adipic acid); C4-C10 alkyldiamine (e.g., (2, 4, 4)-trimethylhexane-1,6-diamine (TMD), isophorone diamine (IPD)); C4 to C10 alkyl diisocyanates (e.g., hexamethylene diisocyanate (HDI), (2, 4, 4)-trimethylhexane-1,6-diisocyanate (TMDI)); alicyclic diisocyanates (e.g. isophorone diisocyanate (IPDI),
1,3-bis(isocyanatomethyl)cyclohexane (H6XDI)); diamine sulfonic acids (e.g., 2-[(2-aminoethyl)amino]ethanesulfonic acid); etc.

Alternatively, the sulfonated polyester-polyurethane binder can be aromatic (or include a commercially available aromatic moiety) and can include aliphatic chains. An example of an aromatic polyester-polyurethane binder that can be used is DISPERCOLL® U42 (CAS #157352-07-3) (Covestro, Germany). Example components used to prepare the DISPERCOLL® U42 or other similar aromatic polyester-polyurethane binders can include aromatic dicarboxylic acids, e.g., phthalic acid; C4 to C10 alkyl dialcohols (e.g., hexane-1,6-diol); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Other types of polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types.

The polyester-polyurethane binders disclosed herein may have a weight average molecular weight (Mw, g/mol or Daltons) ranging from about 20,000 to about 1,000,000. In some examples of the inkjet ink, the polyurethane-based binder is the polyester-polyurethane binder, and the polyester-polyurethane binder has a weight average molecular weight ranging from about 20,000 Mw to about 300,000 Mw. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg KOH/g to about 50 mg KOH/g. In some examples of the inkjet ink, the polyurethane-based binder is the polyester-polyurethane binder, and the polyester-polyurethane binder has an acid number that ranges from about 1 mg KOH/g about 50 mg KOH/g. As other examples, the acid number of the polyester-polyurethane binder can range from about 1 mg KOH/g to about 200 mg KOH/g, from about 2 mg KOH/g to about 100 mg KOH/g, or from about 3 mg KOH/g to about 50 mg KOH/g. For this binder, the term “acid number” refers to the mass of potassium hydroxide (KOH) in milligrams that is used to neutralize one gram of the polyester-polyurethane binder.

To determine this acid number, a known amount of a sample of the polyester-polyurethane binder may be dispersed in water and the aqueous dispersion may be titrated with a polyelectrolyte titrant of a known concentration. In this example, a current detector for colloidal charge measurement may be used. An example of a current detector is the Mütek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC).

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 350 nm. The particle size of any solids herein, including the average particle size of the dispersed polymer binder, can be determined using a NANOTRAC® Wave device, from Microtrac, e.g., NANOTRAC® Wave II or NANOTRAC® 150, etc., which measures particle size using dynamic light scattering. Average particle size can be determined using particle size distribution data (e.g., volume weighted mean diameter) generated by the NANOTRAC® Wave device.

Other examples of polyurethane binder include a polyether-polyurethane. Examples of polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the polyurethane binder include a polycarbonate-polyurethane. Examples of polycarbonate-polyurethanes that may be used as the polyurethane-based binder include IMPRANIL® DLC-F or IMPRANIL® DL 2077 (Covestro (Germany)); or HYDRAN® WLS-213 (DIC Corp. (Japan)); or TAKELAC® W-6110 (Mitsui (Japan)).

### Systems and Methods of Textile Printing

As shown in FIG. 2, a textile printing method is shown in the context of a textile printing system 200. The system can include an ink composition 120 and a fixer fluid 110 for printing on a textile substrate 130. In some examples, the textile printing system can further include various architectures related to ejecting fluids and treating fluids after ejecting onto the print media substrate. For example, the ink composition can be printed from an inkjet pen 220 which includes an ejector 222, such as a thermal inkjet ejector or some other digital ejector technology. Likewise, the fixer fluid can be printed from a fluid jet pen 210 which includes an ejector 212, such as a thermal ejector or some other digital ejector technology. The inkjet pen and the fluid jet pen can be the same type of ejector or can be two different types of ejectors. Both may be thermal inkjet ejectors, for example. Also shown, as can be included in one example, is a heating device 240 to apply heat 245 to the print media substrate to cure the ink composition, e.g., causing the crosslinking reaction to occur or accelerate.

Though a fabric print medium is shown in FIG. 2, the ink compositions 120 and fixer fluids 110 may be suitable for printing on many types of print media substrates, such as papers, films, etc. If printing on fabric, for example, example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the fabric substrates can include polymeric fibers such as, nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., KEVLAR®) polytetrafluoroethylene (TEFLON®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

The fabric substrate can be in one of many different forms, including, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” or “fabric media substrate” does not include materials considered to be paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are bonded together and interlocked together by a chemical treatment process (e.g., a solvent treatment), a mechanical treatment process (e.g., embossing), a thermal treatment process, or a combination of multiple processes.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of the various types of fiber can vary. For example, the amount of the natural fiber can vary from 5 wt % to 95 wt % and the amount of synthetic fiber can range from 5 wt % to 95 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from 10 gsm to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, fillers and lubricants, for example. Alternatively, the fabric substrate may be pre-treated in a solution containing the substances listed above before applying other treatments or coating layers.

Regardless of the substrate, whether paper, natural fabric, synthetic fabric, fabric blend, treated, untreated, etc., the print media substrates printed with the fluid sets of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., TIDE® available from Proctor and Gamble, Cincinnati, Ohio, USA). By measuring OD and/or L*a*b* both before and after washing, %ΔOD and ΔE value can be determined, which is a quantitative way of expressing the difference between the OD and/or L*a*b* prior to and after undergoing the washing cycles. Thus, the lower the %ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the unwanted blue region at hue angles of 275°), ii) compensation for neutral colors or the primed values in the L*C*h differences, iii) compensation for lightness (S_{L}, iv) compensation for chroma (Sc), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used. Further, in 1984, a difference measurement, based on an L*C*h model was defined and called CMC I:c. This metric has two parameters: lightness (I) and chroma (c), allowing users to weigh the difference based on the ratio of I:c that is deemed appropriate for the application. Commonly used values include 2:1 for acceptability and 1:1 for threshold of imperceptibility. This difference metric is also reported in various examples of the present disclosure.

In further detail, the textile printing methods, as shown in the system at 200, can include a fixer fluid 110, which can use an azetidinium-containing polyamine in a liquid fixer vehicle. As described above, the fixer vehicle can include water, a surfactant, and an acid having from 0 to 6 carbon atoms. The fixer fluid can be printed from a fluid jet pen 210 which includes an ejector 212, such as a fluid ejector which can also be a thermal inkjet ejector. As mentioned, in one example, the azetidinium groups of the fixer fluid can interact with the polyurethane binder (of the ink composition 100), the textile substrate 130, or both to form a covalent linkage therewith. In some examples, a heating device 240 can be used to apply heat to the print media substrate to cure the ink composition, e.g., causing the crosslinking reaction to occur or accelerate. Heat can be applied using forced hot air, a heating lamp, an oven, or the like. Curing the ink composition contacted with the fixer fluid on the print media substrate can occur at a temperature from 80° C. to 200° C. for from 5 seconds to 10 minutes, or from 120° C. to 180° C. for from 30 seconds to 5 minutes.

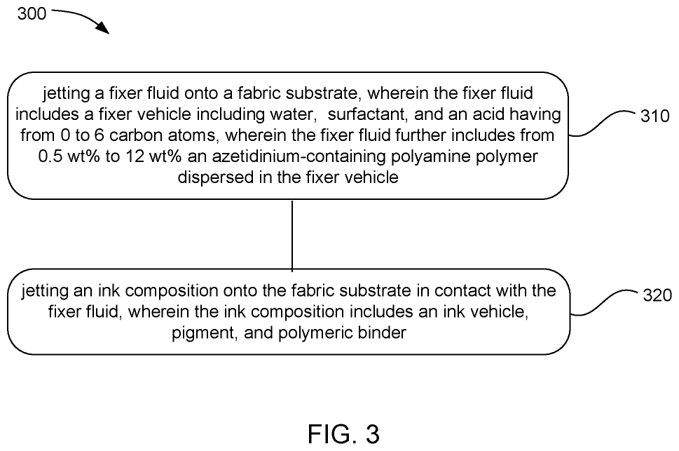

In another example, and as set forth in FIG. 3, a method 300 of printing can include jetting 310 a fixer fluid onto a fabric substrate, wherein the fixer fluid includes a fixer vehicle including water, surfactant, and an acid having from 0 to 6 carbon atoms, wherein the fixer fluid further includes from 0.5 wt % to 12 wt % an azetidinium-containing polyamine polymer dispersed in the fixer vehicle. The method can further include jetting 320 an ink composition onto the fabric substrate in contact with the fixer fluid, wherein the ink composition includes an ink vehicle, pigment, and polymeric binder.

In some specific examples, jetting the fixer fluid onto the print media substrate and jetting the ink composition onto the print media substrate can be performed simultaneously. In other examples, jetting the fixer fluid onto the print media substrate can be performed prior to jetting the ink composition onto the print media substrate. For example, the fixer fluid can be applied to any digital jetting method (e.g. piezo, thermal, mechanical jetting, etc.) and to the print media substrate followed by jetting the ink composition onto the print media substrate. In some examples, the cationic polymer (which includes both types of cationic polymer) and the polyurethane binder can be jetted onto the print media substrate at a weight ratio of from 0.05:1 to 2:1, or from 0.2:1 to 1:1. In other examples, the azetidinium-containing polyamine and the polymeric binder can be jetted onto the print media substrate at a weight ratio from 0.2:1 to 1:1.

For purposes of good jettability, the fixer fluid can typically have a surface tension of from 21 dyne/cm to 55 dyne/cm at 25° C., which is particularly useful for thermal ejector technology, though surface tensions outside of this range can be used for some types of ejector technology, e.g., piezoelectric ejector technology. Surface tension can be measured by the Wilhelmy plate method with a Kruss tensiometer. The viscosity can be from 1.5 cP to 15 cP, from 1.5 cP to 12 cP, or from 1.5 to 8 cP at 25° C. which can be measured at a shear rate of 3,000 Hz, e.g., with a Hydramotion VISCOLITE™ viscometer (Hydramotion Ltd., United Kingdom).

It is also noted that the method of printing can also include heating the fixer fluid and the ink composition to a temperature from 80° C. to 200° C. for a period of from 5 seconds to 10 minutes, or from 120° C. to 180° C. for a period of 30 seconds to 5 minutes, or other suitable temperature and time-frame as disclosed herein. Suitable heating devices can include heating lamps, curing ovens, forced air drying devices, or the like that apply heated air to the media substrate.

It is noted that, as used in this specification and the appended claims, the singular forms “a,” “an,” and “the” include plural referents unless the content clearly dictates otherwise.

As used herein, particle size with respect to the various polymer binders, or any other particles, can be based on volume of the particle size normalized to a spherical shape for diameter measurement, for example. Particle size can be collected using a Malvern ZETASIZER™ system (Malvern Panalytical, United Kingdom), for example. Particle size information can also be determined and/or verified using a scanning electron microscope (SEM).

The term “acid value” or “acid number” refers to the mass of potassium hydroxide (KOH) in milligrams that can be used to neutralize one gram of substance (mg KOH/g), such as the polyurethane or latex polymers disclosed herein. This value can be determined, in one example, by dissolving or dispersing a pre-defined or known quantity of a material in organic solvent and then titrating with a solution of potassium hydroxide (KOH) of known concentration for measurement.

As used herein, the term “about” is used to provide flexibility to a numerical range endpoint by providing that a given value may be “a little above” or “a little below” the endpoint. The degree of flexibility of this term can be dictated by the particular variable based on experience and the associated description herein.

As used herein, a plurality of items, structural elements, compositional elements, and/or materials may be presented in a common list for convenience. However, these lists should be construed as though individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, but also all the individual numerical values or sub-ranges encompassed within that range as if individual numerical values and sub-ranges are explicitly recited. For example, a weight ratio range of about 1 wt % to about 20 wt % should be interpreted to include the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following are illustrative of the application of the principles of the presented fabric print media and associated methods. Numerous modifications and alternatives may be devised without departing from the present disclosure. The appended claims are intended to cover such modifications and arrangements. Thus, while the disclosure has been provided with particularity, the following describes further detail in connection with what are presently deemed to be the acceptable examples.

### Example 1— Preparation of Fixer Fluids

Three experimental fixer fluids and two comparative fixer fluids were prepared. The formulations of these fixer fluids are shown in Table 1. The Experimental fixer fluids included POLYCUP™ 7360A (Solenix LLC, USA) as an azetidinium-containing polyamine polymer, SURFYNOL® 440 or SURFYNOL® 465 (Evonik, Germany) as surfactants, and methanesulfonic acid or nitric acid as the acid compound having 0 to 6 carbon atoms.

In Table 1, weight percentages are based on solids content of active ingredient, e.g., polyamine, surfactant, etc.

TABLE 1
Fixer Fluid Compositions

| | Exp. | Exp. | Exp. | Comp. | Comp. |
|---|---|---|---|---|---|
| Component (wt %) | Fixer 1 | Fixer 2 | Fixer 3 | Fixer 1 | Fixer 2 |
| POLYCUP ™ 7360A | 4 | 4 | 4 | 4 | 4 |
| Methanesulfonic Acid | 1 | | 1 | | |
| Nitric Acid | | 1 | | | |
| SURFYNOL ® 440 | 0.3 | 0.3 | | 0.3 | |
| SURFYNOL ® 465 | | | 0.3 | | |
| Water | Balance | Balance | Balance | Balance | Balance |

The fixer fluids were tested for stability. The pH and viscosity of the fixer fluids were measured after the fixer fluids were prepared and then again after 1 week of accelerated shelf life, which included holding the temperature at 60° C. for 1 week. The pH was measured with an ACCUMET™ XL250 pH meter (Fisher Scientific, USA). The viscosity was measured at a shear rate of 3,000 Hz with a Hydramotion VISCOLITE™ Viscometer (Hydramotion Ltd., United Kingdom). The pH and viscosity data are shown in Table 2.

TABLE 2
Stability

| | | | | Viscosity (cP) | | |
|---|---|---|---|---|---|---|
| | pH | | | | | %Δ |
| | | 1 week | ΔpH after | | 1 week | viscosity |
| Fixer | Initial | ASL | ASL | Initial | ASL | after ASL |
| Exp. 1 | 1.12 | 1.24 | 0.12 | 2.3 | 2.2 | −4.3 |
| Exp. 2 | 0.85 | 1.09 | 0.24 | 2.0 | 1.9 | −5.0 |
| Exp. 3 | 1.08 | 1.33 | 0.25 | 2.3 | 2.2 | −4.3 |
| Comp. 1 | 3.96 | 3.90 | −0.06 | 2.5 | 2.4 | −4.0 |
| Comp. 2 | 4.06 | 3.79 | −0.27 | 2.4 | 2.2 | −8.3 |

The pH and viscosity changed slightly in the experimental fixer fluids after 1 week accelerated shelf life, which indicates that the fixer fluids had good stability. The comparative fixer fluids also had acceptable stability.

The kogation performance of the fixer fluids was tested by printing the fixer fluids from a thermal inkjet printhead until the printhead has printed 200 million drops per nozzle. The kogation performance data are shown in Table 3. “MDPN” is an acronym for Million Drops per Nozzle. “DW 0 MDPN” refers to the initial drop weight. “%Δ DW 200 MDPN” is based on the equation: %Δ DW 200 MDPN=(DW 200 MDPN−DW 0 MDPN)/DW 0 MDPN*100. “DV 0 MDPN” refers to initial drop velocity. “%Δ DV 200 MDPN” is based on the equation: %Δ DV 200 MDPN=(DV 200 MDPN−DV at 0 DMPN)/DV 0 MDPN*100. The “Noz % 200 MDPN” refers to the percentage of nozzles that can fire successfully after 200 million drops per nozzle.

TABLE 3
Kogation Performance

| | | | DW %Δ | | | DV %Δ | |
|---|---|---|---|---|---|---|---|
| | | DW 200 | 200 | | DV 200 | 200 | |
| Fixer | DW 0 | MDPN | MDPN | DV 0 | MDPN | MDPN | Noz % |
| Exp. 1 | 12.1 | 12.5 | 3.1 | 14.9 | 14.9 | 0.0 | 90 |
| Exp. 2 | 12.1 | 12.4 | 2.8 | 14.9 | 14.9 | 0.5 | 75 |
| Exp. 3 | 12.8 | 13.0 | 1.2 | 14.9 | 15.0 | 0.8 | 92 |
| Comp. 1 | 8.0 | 0 | −100 | 6.4 | 0 | −100 | 0 |
| Comp. 2 | 5.2 | 0 | −100 | 8.2 | 0 | −100 | 0 |

The kogation performance test results show that the experimental fixer fluids printed with good drop weight and good drop velocity after 200 million drops per nozzle. The comparative fixer fluids were not printable after 200 million drops per nozzle due to kogation. Therefore, the kogation performance of the experimental fixer fluids was much better than the comparative fixer fluids.

### Example 2— Preparation of Ink Compositions

Two (2) ink compositions were prepared to evaluate their print durability when printed on a fabric substrate with and without the experimental fixer fluids of the present disclosure. More specifically, a black ink composition (Ink K) and a magenta ink composition (Ink M) were prepared. The ink compositions are set forth in Table 4, as follows:

TABLE 4
Black Ink Composition (Ink K) and Magenta Ink Composition (Ink M)

| | | Ink K | Ink M |
|---|---|---|---|
| Component | Category | (wt %) | (wt %) |
| Pigment Dispersion | Colorant | 3 | 3 |
| IMPRANIL ® | Polyurethane Binder | 6 | 6 |
| DLN-SD | | | |
| Glycerol | Organic Co-solvent | 8 | 8 |
| CRODAFOS ™ | Phosphate Ester | 0.5 | 0.5 |
| N3A | Surfactant | | |
| LEG-1 | Organic Co-solvent | 1 | 1 |
| SURFYNOL ® | Surfactant | 0.3 | 0.3 |
| 440 | | | |
| ACTICIDE ® B20 | Biocide | 0.22 | 0.22 |
| Water | Solvent | Balance | Balance |

IMPRANIL ® is available from Covestro (Germany).
CRODAFOS ™ is available from Croda Inc. (USA).
SURFYNOL ® is available from Evonik (Germany).
ACTICIDE ® is available from Thor Specialties, Inc. (USA).
Weight % is based on Solids Content of active ingredient, e.g., polyurethane binder, phosphate ester surfactant, active component in biocide, etc.

### Example 3—Optical Density and Washfastness Durability Performance

Inks K and M from Example 2 were printed on multiple 100 wt % cotton fabric substrates (woven 100 wt % cotton and knitted 100 wt % cotton) with and without Experimental Fixer Fluids 1-3 and Comparative Fixer Fluid 1. Printed samples were washed 5 times with a standard washing machine (Whirlpool Washer, Model WTW5000DW) in warm water (about 40° C.) with detergent (TIDE®). The samples were air dried between washes. The samples were measured for OD and L*a*b* before and after the 5 washes. After the five cycles, optical density (OD) and L*a*b* values were measured for comparison, and delta E (ΔE) values were calculated using the 1976 standard denoted as ΔE_{CIE} as well as the 2000 standard denoted as ΔE₂₀₀₀. ΔE_{CMC} (2:1) values are also reported. The purpose of this study was to investigate whether the fixer fluid including an azetidinium-containing polyamine and an acid having from 0 to 6 carbon atoms would provide good optical density and/or washfastness durability. All data was collected after printing the fixer (if any) at 10 grams per square meter (gsm), then printing the ink composition directly on the fixer (if present) at 20 gsm, and then heat curing at 150° C. for 3 minutes. The results are provided in Tables 5A and 5B, as follows:

TABLE 5A
Optical Density and Washfastness Durability on 100% Cotton Knitted Substrate

| | Ink ID | OD | OD | | | | ΔE_{CMC} |
|---|---|---|---|---|---|---|---|
| Fixer ID | (20 gsm) | (0 wash) | (5 washes) | %ΔOD | ΔE_{CIE} | ΔE₂₀₀₀ | (2:1) |
| None | Ink K | 1.234 | 0.814 | −34.0 | 17.5 | 15.0 | 12.9 |
| Comp. 1 | Ink K | 1.281 | 1.107 | −13.6 | 6.5 | 5.3 | 6.2 |
| Exp. 1 | Ink K | 1.263 | 1.051 | −16.8 | 9.2 | 7.6 | 7.9 |
| Exp. 2 | Ink K | 1.259 | 1.027 | −18.4 | 8.8 | 7.3 | 7.4 |
| Exp. 3 | Ink K | 1.233 | 1.013 | −17.9 | 9.3 | 7.8 | 7.9 |
| None | Ink M | 1.099 | 0.707 | −35.7 | 14.8 | 7.3 | 6.0 |
| Comp. 1 | Ink M | 1.170 | 1.037 | −11.4 | 5.6 | 2.7 | 2.4 |
| Exp. 1 | Ink M | 1.125 | 0.950 | −15.6 | 7.6 | 3.7 | 3.2 |
| Exp. 2 | Ink M | 1.118 | 0.906 | −19.0 | 8.8 | 3.9 | 3.6 |
| Exp. 3 | Ink M | 1.122 | 0.985 | −12.2 | 6.6 | 3.7 | 2.8 |

TABLE 5B
Optical Density and Washfastness Durability on 100% Cotton Woven Substrate

| Fixer ID | Ink ID | OD | OD | | | | ΔE_{CMC} |
|---|---|---|---|---|---|---|---|
| (10 gsm) | (20 gsm) | (0 wash) | (5 washes) | %ΔOD | ΔE_{CIE} | ΔE₂₀₀₀ | (2:1) |
| None | Ink K | 1.146 | 0.886 | −22.7 | 12.1 | 10.5 | 10.6 |
| Comp. 1 | Ink K | 1.189 | 1.115 | −6.2 | 4.0 | 3.7 | 4.8 |
| Exp. 1 | Ink K | 1.219 | 1.134 | −7.0 | 5.1 | 4.4 | 5.4 |
| Exp. 2 | Ink K | 1.235 | 1.132 | −8.4 | 4.7 | 4.1 | 5.0 |
| Exp. 3 | Ink K | 1.219 | 1.123 | −7.8 | 4.7 | 4.2 | 5.1 |
| None | Ink M | 0.991 | 0.820 | −17.2 | 9.0 | 4.5 | 3.8 |
| Comp. 1 | Ink M | 1.100 | 1.046 | −4.9 | 3.7 | 1.7 | 1.8 |
| Exp. 1 | Ink M | 1.145 | 1.070 | −6.6 | 4.5 | 2.2 | 2.2 |
| Exp. 2 | Ink M | 1.172 | 1.072 | −8.5 | 4.4 | 2.1 | 2.1 |
| Exp. 3 | Ink M | 1.146 | 1.084 | −5.4 | 3.9 | 1.8 | 1.9 |

As can be seen in the data presented in Tables 5A and 5B, initial optical density (OD) was substantially better on both types of cotton fabric when the experimental fixer formulations of the present disclosure were used, compared to not using the fixer fluid. Furthermore, after 5 washes, the % ΔOD, ΔE_{CIE}, ΔE₂₀₀, and ΔE_{CMC}, the black ink composition (Ink K) and the magenta ink composition (Ink M) performed better with respect to washfastness durability in every instance using every washfastness metric when the fixer fluids were used compared to samples where a fixer fluid was not used. The comparative fixer fluid also provided better washfastness compared to using no fixer fluid.

While the present technology has been described with reference to certain examples, various modifications, changes, omissions, and substitutions can be made without departing from the spirit of the disclosure. It is intended, therefore, that the disclosure be limited by the scope of the following claims.

What is claimed is:

1. A fixer fluid, comprising:
a fixer vehicle including water, a surfactant, and an acid having from 0 to 6 carbon atoms; and
from 0.5 wt % to 12 wt % of an azetidinium-containing polyamine polymer dispersed in the fixer vehicle.

2. The fixer fluid of claim 1, wherein the acid does not include a carboxyl group, an amino group, a thiol group, or a hydroxyl group where the hydroxyl group is attached to a carbon atom.

3. The fixer fluid of claim 1, wherein the acid is a sulfonic acid, a nitric acid, or a phosphoric acid.

4. The fixer fluid of claim 1, wherein the acid is included in an amount of from 0.1 wt % to 5 wt % with respect to the total weight of the fixer fluid.

5. The fixer fluid of claim 1, wherein the fixer fluid does not include an anti-kogation additive other than the acid.

6. The fixer fluid of claim 1, wherein the azetidinium-containing polyamine polymer includes from 2 to 12 carbon atoms between individual amine groups.

7. The fixer fluid of claim 1, wherein the azetidinium-containing polyamine polymer has a molar ratio of crosslinked or uncrosslinked azetidinium groups to amine groups from 0.1:1 to 10:1.

8. A fluid set for textile printing, comprising:
an ink composition including an aqueous ink vehicle, pigment, and polymeric binder; and
a fixer fluid including:
a fixer vehicle including water, a surfactant, and an acid having from 0 to 6 carbon atoms, and
from 0.5 wt % to 12 wt % an azetidinium-containing polyamine polymer dispersed in the fixer vehicle.

9. The fluid set of claim 8, wherein the acid does not include a carboxyl group, an amino group, a thiol group, or a hydroxyl group where the hydroxyl group is attached to a carbon atom.

10. The fluid set of claim 8, wherein the acid is a sulfonic acid, a nitric acid, or a phosphoric acid.

11. The fluid set of claim 8, wherein the azetidinium-containing polyamine polymer includes from 2 to 12 carbon atoms between individual amine group, and has a molar ratio of crosslinked or uncrosslinked azetidinium groups to amine groups from 0.1:1 to 10:1.

12. The fluid set of claim 8, wherein the polymeric binder in the ink composition includes a polyester polyurethane, an acrylic latex, or a combination thereof.

13. A method of textile printing, comprising:
jetting a fixer fluid onto a fabric substrate, wherein the fixer fluid comprises a fixer vehicle including water, a surfactant, and an acid having from 0 to 6 carbon atoms, wherein the fixer fluid further comprises from 0.5 wt % to 12 wt % of an azetidinium-containing polyamine polymer dispersed in the fixer vehicle; and
jetting an ink composition onto the fabric substrate in contact with the fixer fluid, wherein the ink composition includes an aqueous ink vehicle, pigment, and polymeric binder.

14. The method of claim 13, further comprising heating the fabric substrate having the fixer fluid and the aqueous ink composition applied thereto to a temperature from 80° C. to 200° C. for a period from 5 seconds to 10 minutes.

15. The method of claim 13, wherein:
the acid does not include a carboxyl group, an amino group, a thiol group, or a hydroxyl group where the hydroxyl group is attached to a carbon atom;
wherein the azetidinium-containing polyamine polymer includes from 2 to 12 carbon atoms between individual amine groups; and
wherein the azetidinium-containing polyamine polymer has a molar ratio of crosslinked or uncrosslinked azetidinium groups to amine groups from 0.1:1 to 10:1.
